(19) United States
(12) Patent Application Publication
(10) Pub. No.: US 2020/0189056 A1
(43) Pub. Date: Jun. 18, 2020

(54) MACHINE TOOL

(71) Applicant: OKUMA Corporation, Niwa-gun (JP)

(72) Inventors: Yuichi TAZUKE, Niwa-gun (JP); Shoichi MORIMURA, Niwa-gun (JP)

(21) Appl. No.: 16/711,681

(22) Filed: Dec. 12, 2019

(30) Foreign Application Priority Data
Dec. 13, 2018 (JP) 2018-233693

(51) Int. Cl. B23Q 3/155

(52) U.S. Cl. CPC B23Q 3/1554; B23Q 2003/155407

(57) ABSTRACT

A machine tool stores numerous end effectors without a need to newly provide an end effector storage internally or externally to the machine tool. A temporary base for the end effector is disposed inside the machine tool. The end effector is passed from an internally-mounted robot to a tool post via the temporary base. A tool of the machine tool can be exchanged by attaching the end effector to the tool post. The end effector is stored in a tool storage of the machine tool

### CROSS REFERENCE TO RELATED APPLICATION

The present application claims priority under 35 USC 119 to Japanese Patent Application No. 2018-233693 filed on Dec. 13, 2018, which is incorporated herein by reference in its entirety including the specification, claims, drawings, and abstract.

### TECHNICAL FIELD

The present disclosure relates to a machine tool.

### BACKGROUND

In recent years, a demand for automation and high performance of machine tools is increasing more than ever. In order to realize automation, peripheral devices such as automatic changing devices and workpiece supplying devices are used. For example, an automatic tool changer (ATC) and an automatic pallet changer (APC) are used as the automatic changing devices, whereas a loader and a bar feeder are used as the workpiece supplying devices. In order to realize high performance, internal measurements using sensors and intelligence optimization are performed. Use of robots having a high degree of freedom and capable of various operations are expected to be increased to further promote automation and improvement of performance.

As one example use of a robot, JP 2010-36285A discloses a robot that is installed external to a machine tool, and attaches and removes a workpiece to or from the machine tool. JP 2016-55370A discloses that a robot installed external to a machine tool enters in the machine tool and exchanges a tool. JP 4955522 B discloses that a robot installed external to a machine tool exchanges a jaw of a lathe chuck.

In order to use a robot to perform supportive operations of processing in a machine tool, because different end effectors are used for different operations, the required number of end effectors depends on the number of types of the operations. To enable the robot to automatically exchange between multiple end effectors, the end effectors must be stored within an accessible area of the robot.

However, because the accessible area of the robot is limited to inside the machining chamber of a machine tool and around its external periphery, only a limited number of end effectors can be stored, thereby restricting the number of types of operations. Furthermore, providing a new end effector storage stand inside or outstand the machine tool would be problematic because of a cost required for the stand and a specific design of the stand required for each end effector to be used.

### SUMMARY

The present disclosure provides techniques to enable storage of numerous end effectors without a need to newly provide an end effector storage inside or outside a machine tool.

The present disclosure discloses a machine tool that processes a workpiece using multiple tools. The machine tool includes an internally or externally mounted robot, a tool storage in which the multiple tools are to be stored, and an exchange device that is configured to store, in the tool storage, an end effector detached from the robot.

According to one embodiment of the present disclosure, the machine tool may further include an end-effector temporary base. The exchange device may store, in the tool storage, the end effector that has been temporarily placed on the end-effector temporary base.

According to another embodiment of the present disclosure, the exchange device may include a tool attached portion.

According to yet another embodiment of the present disclosure, the exchange device may include a tool attached portion and an exchange arm.

According to yet another embodiment of the present disclosure, the machine tool may further include an end effector holder that is configured to hold the end effector. A connector of the end effector to the end effector holder may also serve as a connector to the robot. Alternatively, the connector of the end effector to the end effector holder may be provided separately from the connector to the robot. The end effector holder may be unitedly formed with the end effector.

According to yet another embodiment of the present disclosure, the machine tool may further include a protective device that is configured to prevent entry of swarf or cutting liquid into a connected portion.

According to yet another embodiment of the present disclosure, the machine tool may further include a cleaning device that is configured to clean the end effector. The cleaning device may perform cleaning by emitting air blow or coolant.

According to the present disclosure, numerous end effectors can be stored without newly providing an end effector storage inside or outside the machine tool. In other words, by bringing the tool storage of the machine tool into focus, numerous end effectors can be stored in a reduced space by storing the end effectors in the tool storage. Because numerous end effectors can be stored in the present disclosure, a machine tool having an automatic system that performs various supportive operations such as workpiece transportation, cleaning, and measurement can be provided.

### BRIEF DESCRIPTION OF DRAWINGS

Embodiments of the present disclosure will be described based on the following figures, wherein:

FIG. 1 is a configuration diagram of a machine tool before an end effector is stored according to an embodiment of the present disclosure;

FIG. 2 is a configuration diagram of the machine tool with the end effector being temporarily placed according to an embodiment of the present disclosure;

FIG. 3 is a configuration diagram of the machine tool when connecting the end effector to an end-effector holder according to an embodiment of the present disclosure;

FIG. 4 is a plan view of the end effector connected to the end-effector holder according to an embodiment of the present disclosure;

FIG. 5 is a plan view of an end effector according to another embodiment of the present disclosure;

FIG. 6 is a plan view of the end effector before being connected to the end-effector holder according to an embodiment of the present disclosure;

FIG. 7 is a plan view of an end effector and an end-effector holder being connected together according to another embodiment of the present disclosure; and

FIG. 8 is a plan view of the end effector and the end-effector holder shown in FIG. 7, with the two connected together.

### DETAILED DESCRIPTION

In description below, embodiments of the present disclosure are described with reference to the drawings.

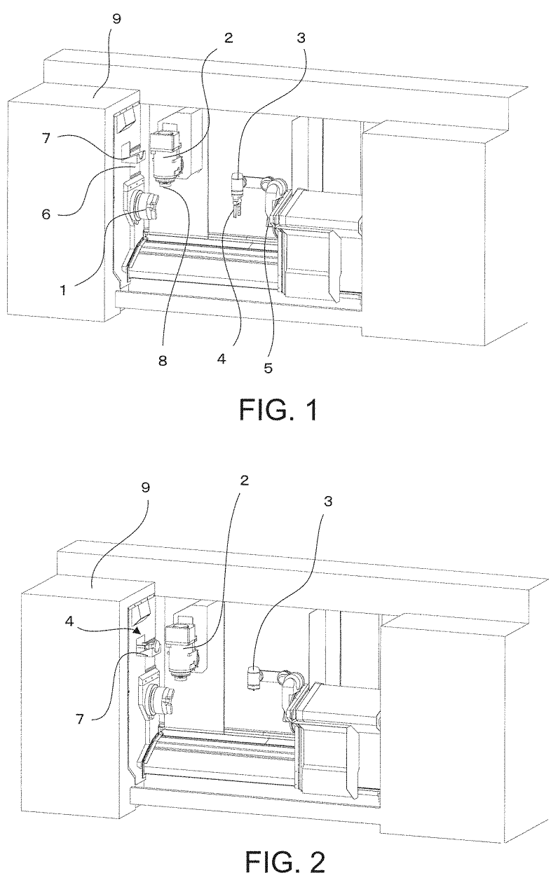

FIG. 1 shows a configuration diagram of a machine tool according to an embodiment of the present disclosure. The machine tool according to the present embodiment may be a multi-tasking machine using a lathe. The machine tool includes a spindle 1 that holds a workpiece, a tool post 2 that processes the workpiece using a tool, an internally-mounted robot 3, an end effector 4 attached to a distal end of the internally-mounted robot 3, an opposing spindle 5 that opposes the spindle 1, and a tool storage 9.

The tool post 2 serves as a tool attached portion. The tool post 2 can emit through-tool coolant to the center of the attached tool. The tool post 2 can also emit through-tool air blow to clean inside the tool post 2. The tool post 2 includes a tool connector 8a (not shown) for connecting the tool. An end effector holder 8 for holding the end effector 4 may be attached to the tool post 2.

The end effector 4 is attached to the distal end of the internally-mounted robot 3. The end effector 4 is connected to the internally-mounted robot 3 via a robot-and-end effector connector 4a (not shown). The robot-and-end effector connector 4a is described further below in more detail. Although a hand that can hold a workpiece or the like is exemplarily shown as the end effector 4 in the drawings, the present disclosure is not limited to this example.

The tool storage 9 stores exchangeable tools that are to be attached to the tool post 2. The tool storage 9 may have a tool transporting function to enable storage of numerous tools. The tool storage 9 may include a shutter 6 that partitions between the tool storage 9 and the machining chamber of the machine tool. By opening the shutter 6, tools can be passed through the opening. The tool storage 9 may further include a temporary base 7 on which the end effector 4 is temporarily placed in the machining chamber.

The machine tool according to the present embodiment is configured as described above. Steps to store the end effector 4 detached from the distal end of the internally-mounted robot 3 in the tool storage 9 are described below.

FIG. 2 shows the end effector 4 that is temporarily placed on the temporary base 7 of the tool storage 9.

The internally-mounted robot 3 moves to the temporary base 7 of the tool storage 9 and temporarily places the end effector 4 on the temporary base 7. After placing the end effector 4 on the temporary base 7, the end effector 4 is detached from the internally-mounted robot 3, which then retracts in a direction away from the temporary base 7. In this way, as shown in FIG. 2, the end effector 4 is temporarily placed on the temporary base 7, whereas the internally-mounted robot 3 is at a retracted position away from the temporary base 7.

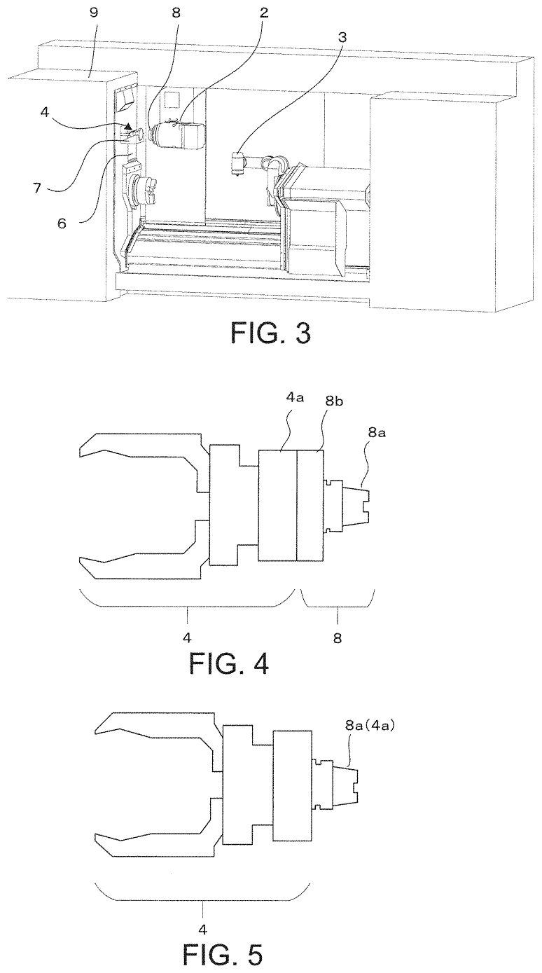

FIG. 3 shows the tool post 2 and the end effector 4 before connecting the two.

After the end effector 4 is temporarily placed on the temporary base 7, the tool post 2 moves towards the temporary base 7 and connects the attached end effector holder 8 to the robot-and-end effector connector 4a of the end effector 4 on the temporary base 7. Before the connection, the robot-and-end effector connector 4a of the end effector 4 is cleaned with through-tool air blow from the tool post 2. During the connection, coolant is emitted to the end effector holder 8 so as to use the force to connect the end effector holder 8 to the robot-and-end effector connector 4a. The end effector holder 8 and the robot-and-end effector connector 4a are disconnected and separated away from each other using through-tool coolant from the tool post 2. The connection is maintained while the through-tool coolant is not emitted.

For cleaning the robot-and-end effector connector 4a, not only the cleaning using the air blow but also other method including cleaning using coolant may be used. Furthermore, cleaning may be performed not only by the tool post 2 but also by a cleaning nozzle attached to the internally-mounted robot 3 or the machine tool.

Although the tool post 2 is described to have a function to emit coolant, the tool post 2 is not limited to such an embodiment. The tool post 2 may have no function to emit coolant. The connection between the end effector holder 8 and the robot-and-end effector connector 4a may be achieved by not only the emission of coolant but also by other methods. For example, these two may be connected using a rotary force of the tool post 2 or an axial movement of the tool post 2. Further, these methods, or other methods, may be combined to connect them.

After the end effector holder 8 and the robot-and-end effector connector 4a are connected, the tool post 2 moves to a tool exchange position in front of the shutter 6 that is a partition between the tool storage 9 and the machining chamber, while maintaining the end effector holder 8 united with the end effector 4. At the tool exchange position, the exchange arm stores, in the tool storage 9, the end effector holder 8 that is united with the end effector 4 and detached from the tool post 2. The above described steps compete the storage of the end effector 4 detached from the distal end of the internally-mounted robot 3 in the tool storage 9.

Steps to retrieve the end effector 4 are described below.

The end effector holder 8 united with the end effector 4 to be used next is retrieved from the tool storage 9 and attached to the tool post 2 by the exchange arm.

The tool post 2 moves towards the temporary base 7, while maintaining the end effector holder 8 being exchanged by the exchange arm and united with the end effector 4 to be used next. After the movement, the tool post 2 temporarily places, on the temporary base 7, the end effector holder 8 united with the end effector 4 to be used next and detaches the end effector 4 from the end effector holder 8. After the detachment, the robot-and-end effector connector 4a of the end effector 4 is cleaned using the through-tool air blow of the tool post 2.

Then, the internally-mounted robot 3 moves to the temporary base 7 to connect the temporarily placed end effector 4 at the robot-and-end effector connector 4a.

Also for this cleaning, not only the cleaning using the air blow but also another method, including cleaning using coolant, may be used. Furthermore, cleaning may be performed not only by the tool post 2 but also by the cleaning nozzle or other elements attached to the internally-mounted robot 3 or the machine tool.

By the above steps, the end effector 4 stored in the tool storage 9 is retrieved from the tool storage 9 and attached to the internally-mounted robot 3.

The above steps are described below while focusing on the end effector 4.

Steps to store the end effector 4 in the tool storage 9:

(1) The end effector 4 is attached to the distal end of the internally-mounted robot 3.
(2) The end effector 4 is temporarily placed on the temporary base 7 of the tool storage 9 by the internally-mounted robot 3.
(3) The end effector 4 is connected to the end effector holder 8 of the tool post 2 by the tool post 2.
(4) The end effector 4 is moved to in front of the shutter 6 of the tool storage 9 by the tool post 2.
(5) The end effector 4 is stored in the tool storage 9 by the exchange arm.
Steps to retrieve the end effector 4 from the tool storage 9:
(1) The end effector 4 is stored in the tool storage 9.
(2) The end effector 4 is retrieved from the tool storage 9 and attached to the tool post 2 by the exchange arm.
(3) The end effector 4 is temporality placed on the temporary base 7 of the tool storage 9 by the tool post 2.
(4) On the temporary base 7, the end effector 4 is detached from the end effector holder 8 by the tool post 2.
(5) The end effector 4 is attached to the distal end of the internally-mounted robot 3 by the internally-mounted robot 3.

As described above, in the above embodiment, the temporary base 7 for the end effector 4 is provided inside the machine tool. The end effector 4 is passed from the internally-mounted robot 3 to the tool post 2 to be connected thereto via the temporary base 7. Because the machine tool has a tool exchange function for the tool post 2, the tool exchange function can be used to store the end effector 4 in the tool storage 9 of the machine tool by attaching the end effector 4 to the tool post 2. In the embodiments according to the present disclosure, because the end effector 4 is stored in the tool storage 9 not by the internally-mounted robot 3 itself, the internally-mounted robot 3 is only required to move to the temporary base 7 to temporarily place the end effector 4 on the temporary base 7. In this way, the end effector 4 can be stored in the tool storage 9 even when the accessible area of the internally-mounted robot 3 is limited. In the present embodiment, the end effector 4 is stored in the tool storage 9 through the cooperation between the internally-mounted robot 3 and the tool post 2 via the temporary base 7. More specifically, the end effector 4 is stored in the tool storage 9 through the cooperation between the internally-mounted robot 3, the tool post 2, and the exchange arm to exchange the tools via the temporary base 7. The tool post 2 to which the tool is attached and the exchange arm serve as an exchange device.

Because the temporary base 7 in the embodiments according to the present disclosure is merely a portion on which the end effector 4 is temporarily placed, the temporary base 7 can be more simple, thereby reducing the cost increase, in comparison with a case of newly providing a permanent storage portion for the end effector 4.

FIG. 4 is a plan view of the end effector 4 with the end effector holder 8 connected thereto.

A hand is formed at a distal end of the end effector 4, whereas the robot-and-end effector connector 4a is provided at a proximal end on the other side. The robot-and-end effector connector 4a affects the weight capacity of the internally-mounted robot 3. While the robot-and-end effector connector 4a needs to have a clamp force corresponding to the size and operations of the end effector 4, the robot-and-end effector connector 4a also needs to be light in weight and compact in size. Although the basic function of the robot-and-end effector connector 4a is to connect the end effector 4 and the internally-mounted robot 3, the robot-and-end effector connector 4a is also used to connect the end effector 4 and the tool post 2 via the end effector holder 8.

The end effector holder 8 includes the tool connector 8a and a holder-and-end effector connector 8b. The tool connector 8a needs to have a clamp force strong enough to clamp the tool while bearing a machining load.

When the robot-and-end effector connector 4a of the end effector 4 is connected to the holder-and-end effector connector 8b of the end effector holder 8, the connected portion can be protected from cutting fluid or swarf by sealing the outer circumference of the robot-and-end effector connector 4a of the end effector 4 by a protective element, such as an O-ring attached to the holder-and-end effector connector 8b of the end effector holder 8.

As the protective device for the connected portion between the robot-and-end effector connector 4a and the holder-and-end effector connector 8b, not only the O-ring but also other sealing methods such as a labyrinth structure may be used.

Although the robot-and-end effector connector 4a of the end effector 4 and the holder-and-end effector connector 8b of the end effector holder 8 shown in FIG. 4 are described as different elements, these elements may be unitedly formed.

FIG. 5 shows a plan view of the end effector 4 when the end effector 4 and the end effector holder 8 are unitedly formed. In comparison between FIG. 4 and FIG. 5, the robot-and-end effector connector 4a also serves as the tool connector 8a in FIG. 5.

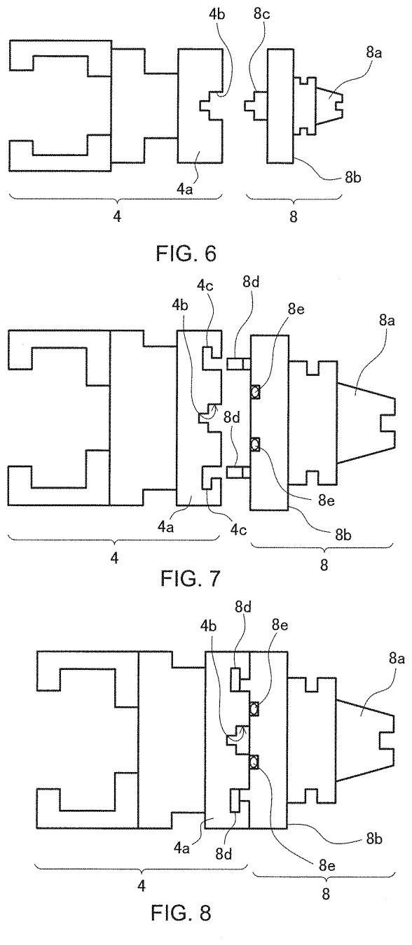

FIG. 6 shows a plan view of the end effector 4 shown in FIG. 4 before being connected. A recess 4b including a stepped surface is formed on a proximal end surface (the surface facing the end effector holder 8) of the robot-and-end effector connector 4a of the end effector 4. A protrusion 8c including a stepped surface is formed on a distal end surface (the surface facing the end effector 4). The end effector 4 and the end effector holder 8 are connected by inserting the protrusion 8c into the recess 4b. Although the protrusion 8c and the recess 4b are shown in the drawings, these are merely examples. Any fastening means may be used.

FIG. 7 and FIG. 8 show respective plan views of the end effector 4 shown in FIG. 4 before and after the connection. At least one recess 4c including a bent portion is formed in the proximal end surface (the surface facing the end effector holder 8) of the robot-and-end effector connector 4a of the end effector 4. At least one O-ring 8e and at least one protrusion 8d including a pivotable portion are formed on a distal end surface (the surface facing the end effector 4) of the holder-and-end effector connector 8b of the end effector holder 8. The end effector 4 and the end effector holder 8 are connected together by inserting the protrusion 8d into the recess 4c and pivoting the pivotable portion. The recess 4b can be protected from cutting fluid or swarf by sealing therebetween with a protection element, such as the O-ring 8e.

Although embodiments of the present disclosure are described above, the present disclosure is not limited to these embodiments. Various modifications are applicable.

For example, although the end effector 4 is temporarily placed on the temporary base 7 that is disposed at the tool storage 9, the temporary base 7 may be provided not separately. In that case, the end effector 4 may be temporarily placed on a portion of any one of the exchange arm, the spindle 1, the opposing spindle 5, and any other element disposed inside or outside the machine tool. Any portion on which the end effector 4 is temporarily placed may serve as the temporal base for the end effector 4.

Alternatively, when the internally-mounted robot 3 can be moved to the tool exchange position with the end effector 4 attached to the internally-mounted robot 3, the end effector 4 attached to the internally-mounted robot 3 may be directly exchanged by the exchange arm after the internally-mounted robot 3 is moved to the tool exchange position.

Although the internally-mounted robot 3 is described in the above embodiments as an example, the present disclosure is not limited to the internally-mounted robot 3. The end effector 4 attached to an externally-mounted robot may be stored in the tool storage 9.

Furthermore, although a multi-tasking machine including a lathe is described as an example, the present disclosure is not limited to such embodiments. It is apparent that the present disclosure may be applied to other applications such as a machining center.

1. A machine tool processing a workpiece using a plurality of tools, the machine tool comprising:
an internally or externally mounted robot;
a tool storage in which the plurality of tools are to be stored; and
an exchange device configured to store an end effector detached from the robot in the tool storage.

2. The machine tool according to claim 1, wherein
the machine tool further comprises an end-effector temporary base, and
the exchange device configured to store, in the tool storage, the end effector having been temporarily placed on the end-effector temporary base.

3. The machine tool according to claim 1, wherein
the exchange device comprises a tool attached portion.

4. The machine tool according to claim 1, wherein
the exchange device comprises a tool attached portion and an exchange arm.

5. The machine tool according to claim 1, wherein
the machine tool further comprises an end effector holder configured to hold the end effector.

6. The machine tool according to claim 5, wherein
a connector of the end effector to the end effector holder also serves as a connector to the robot.

7. The machine tool according to claim 5, wherein
a connector of the end effector to the end effector holder is provided separately from a connector to the robot.

8. The machine tool according to claim 5, wherein
the machine tool further comprises a protective device configured to prevent entry of swarf or cutting liquid into a connected portion.

9. The machine tool according to claim 1, wherein
the machine tool further comprises an end effector holder configured to hold the end effector, and
the end effector holder is unitedly formed with the end effector.

10. The machine tool according to claim 1, wherein
the machine tool further comprises a cleaning device configured to clean the end effector.

11. The machine tool according to claim 10, wherein
the cleaning device performs cleaning by emitting air blow or coolant.
